(19) United States
(12) Patent Application Publication
(10) Pub. No.: US 2016/0032976 A1
(43) Pub. Date: Feb. 4, 2016

(54) COMPONENT CONFIGURED FROM MARTENSITIC STAINLESS STEEL

(71) Applicant: UNITED TECHNOLOGIES CORPORATION, Hartford, CT (US)

(72) Inventors: Herbert A. Chin, Indian Land, NC (US); William P. Ogden, Glastonbury, CT (US); David A. Haluck, Stuart, FL (US); Ronald F. Spitzer, Charlotte, NC (US)

(21) Appl. No.: 14/776,190

(22) PCT Filed: Jan. 15, 2014
(86) PCT No.: PCT/US14/11680

§ 371 Date: Sep. 14, 2015

Related U.S. Application Data
(60) Provisional application No. 61/788,690, filed on Mar. 15, 2013.

(51) Int. Cl. F16C 33/62; C22C 38/52; C22C 38/48; C22C 38/44; C22C 38/02; C22C 38/50; C22C 38/58; C22C 38/46

(52) U.S. Cl. CPC F16C 33/62; C22C 38/58; C22C 38/52; C22C 38/46; C22C 38/44; C22C 38/02; C22C 38/50; C22C 38/48

(57) ABSTRACT

A rolling element bearing includes a plurality of bearing components, which include one or more rolling elements, an inner ring and an outer ring. A first of the bearing components includes martensitic stainless steel configured with a core and a hardened case. The martensitic stainless steel of the core includes approximately 8% by weight or more chromium. The martensitic stainless steel of the hardened case has a grain size that is substantially equal to or finer than ASTM grain size #7. The martensitic stainless steel of the hardened case includes approximately 6% by weight or more chromium, and carbon. Molecules that include the carbon are substantially uniformly dispersed within the hardened case.

Applicant hereby claims priority to U.S. Patent Application No. 61/788,690 filed Mar. 15, 2013, the disclosure of which is herein incorporated by reference.

This invention was made with government support under Contract No. FA8650-09-D-2923 0004 awarded by the United States Air Force. The government may have certain rights in the invention.

### BACKGROUND OF THE INVENTION

1. Technical Field

This disclosure relates generally to martensitic stainless steel and, more particularly, to a martensitic stainless steel component configured for use in a mechanical system such as a turbine engine.

2. Background Information

A component of a bearing for a turbine engine may be constructed from martensite stainless steel. To increase surface hardness of the bearing component, the martensite stainless steel may be carburized. Carbon, for example, may be diffused into a surface of the bearing component. The carbon, however, may form relatively large carbide precipitates along grain boundaries, which may decrease the strength of stainless steel. In addition, the stainless steel may have a relatively coarse grain size, which may further decrease the strength and ductility of the stainless steel. Such a reduction in strength and ductility may increase the bearing component's susceptibility to spallation.

### SUMMARY OF THE DISCLOSURE

According to an aspect of the invention, a rolling element bearing is provided that includes a plurality of bearing components. The bearing components include one or more rolling elements, an inner ring and an outer ring. A first of the bearing components includes martensitic stainless steel configured with a core and a hardened case. The martensitic stainless steel of the core includes approximately 8% by weight or more chromium. The martensitic stainless steel of the hardened case has a grain size that is substantially equal to or finer than ASTM grain size #7. The martensitic stainless steel of the hardened case includes approximately 6% by weight or more chromium. The martensitic stainless steel of the hardened case also includes carbon, where molecules that include the carbon are substantially uniformly dispersed within the hardened case.

According to another aspect of the invention, another rolling element bearing is provided that includes a plurality of bearing components. The bearing components include one or more rolling elements, an inner ring and an outer ring. A first of the bearing components include martensitic stainless steel, which includes iron, chromium, cobalt, vanadium, molybdenum, nickel, manganese, silicon and carbon. A core of the martensitic stainless steel includes approximately 8% by weight or more of the chromium. A case of the martensitic stainless steel has a grain size that is substantially equal to or finer than ASTM grain size #7. The case includes approximately 6% by weight or more of the chromium, and between approximately 0.8 and approximately 4 percent by weight of the carbon. Molecules including carbon are substantially uniformly dispersed within the case.

According to still another aspect of the invention, a martensitic stainless steel component is provided that includes a body comprising martensitic stainless steel. A core of the martensitic stainless steel includes about 8% by weight or more chromium. A hardened case of the martensitic stainless steel has a grain size that is substantially equal to or finer than ASTM grain size #7. The hardened case includes about 6% by weight or more chromium, and carbon. Molecules including the carbon are substantially uniformly dispersed within the hardened case.

The body may form a component of a rolling element bearing such as, for example, a rolling element, an inner ring or an outer ring.

The martensitic stainless steel may include one or more of the following: nitrogen, manganese, nickel, molybdenum, tungsten and silicon.

The hardened case may have a depth that extends from a surface of the first of the bearing components towards the core. The depth may be substantially equal to between approximately 0.01 and approximately 0.06 inches.

The hardened case may have a hardness that is substantially equal to or greater than about 58 RC. The hardened case may also or alternatively have a substantially uniform hardness. The hardened case may also or alternatively have a compressive stress that is substantially equal to or greater than approximately 5 ksi.

The core may have a fracture toughness that is substantially equal to or greater than approximately 25 ksi square root inch.

The grain size may be substantially equal to or finer than ASTM grain size #9.

The martensitic stainless steel of the hardened case may include between approximately 0.8 and approximately 4 percent by weight of the carbon.

The molecules including the carbon may include at least one of carbides and carbo-nitrides. A volume fraction of the carbides and/or carbo-nitrides within the hardened case may be substantially equal to or greater than about 5 percent by volume. The carbides and/or carbo-nitrides may also or alternatively have a moderate or finer size; e.g., between about 0.01 microns and about 100 microns.

The martensitic stainless steel of the hardened case may include between about 2 and about 20 percent retained austenite.

The first of the bearing components may be configured as or otherwise include one of the rolling elements. Alternatively, the first of the bearing components may be configured as or otherwise include the inner ring or the outer ring. In addition, one or more of the rolling elements may each be configured from ceramic.

The foregoing features and the operation of the invention will become more apparent in light of the following description and the accompanying drawings.

### BRIEF DESCRIPTION OF THE DRAWINGS

FIG. 1 is a side cutaway illustration of a geared turbine engine;

FIG. 2 is a side sectional illustration of a bearing for the turbine engine of FIG. 1;

FIG. 3 is a sectional illustration of an enlarged portion of one of the components of the bearing of FIG. 2;

FIG. 4 is a graphical depiction of hardness of the bearing component of FIG. 3 as a function of depth below a surface of the bearing component;

FIG. 5 is a graphical depiction of residual stress of the bearing component of FIG. 3 as a function of depth below a surface of the bearing component;

FIG. 6 is a pictorial sectional illustration of an enlarged portion of a case of the bearing component of FIG. 3;

FIG. 7 is a flow diagram of a process for forming a component using martensitic stainless steel; and

FIG. 8 is a graphical depiction of reduction of grain size of martensitic stainless steel as a function of temperature during thermo-mechanical processing.

### DETAILED DESCRIPTION OF THE INVENTION

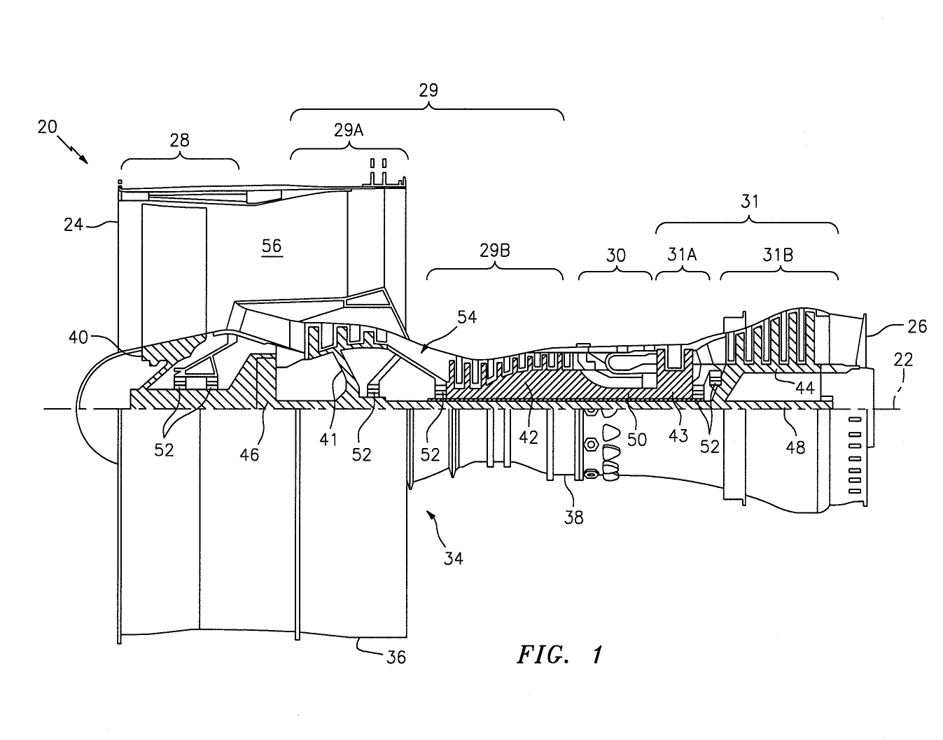

FIG. 1 is a side cutaway illustration of a geared turbine engine 20 that extends along an axis 22 between an upstream airflow inlet 24 and a downstream airflow exhaust 26. The engine 20 includes a fan section 28, a compressor section 29, a combustor section 30 and a turbine section 31. The compressor section 29 includes a low pressure compressor (LPC) section 29A and a high pressure compressor (HPC) section 29B. The turbine section 31 includes a high pressure turbine (HPT) section 31A and a low pressure turbine (LPT) section 31B. The engine sections 28-31 are arranged sequentially along the axis 22 within an engine housing 34, which includes a first engine case 36 (e.g., a fan nacelle) and a second engine case 38 (e.g., a core nacelle).

Each of the engine sections 28, 29A, 29B, 31A and 31B includes a respective rotor 40-44. Each of the rotors 40-44 includes a plurality of rotor blades arranged circumferentially around and connected to (e.g., formed integral with or attached to) one or more respective rotor disks. The fan rotor 40 is connected to a gear train 46; e.g., an epicyclic gear train. The gear train 46 and the LPC rotor 41 are connected to and driven by the LPT rotor 44 through a low speed shaft 48. The HPC rotor 42 is connected to and driven by the HPT rotor 43 through a high speed shaft 50. The low and high speed shafts 48 and 50 are rotatably supported by a plurality of bearings 52. Each of the bearings 52 is connected to the second engine case 38 by at least one stator such as, for example, an annular support strut.

Air enters the engine 20 through the airflow inlet 24, and is directed through the fan section 28 and into an annular core gas path 54 and an annular bypass gas path 56. The air within the core gas path 54 may be referred to as “core air”. The air within the bypass gas path 56 may be referred to as “bypass air”. The core air is directed through the engine sections 29-31 and exits the engine 20 through the airflow exhaust 26. Within the combustor section 30, fuel is injected into and mixed with the core air and ignited to provide forward engine thrust. The bypass air is directed through the bypass gas path 56 and out of the engine 20 to provide additional forward engine thrust, or reverse thrust via a thrust reverser.

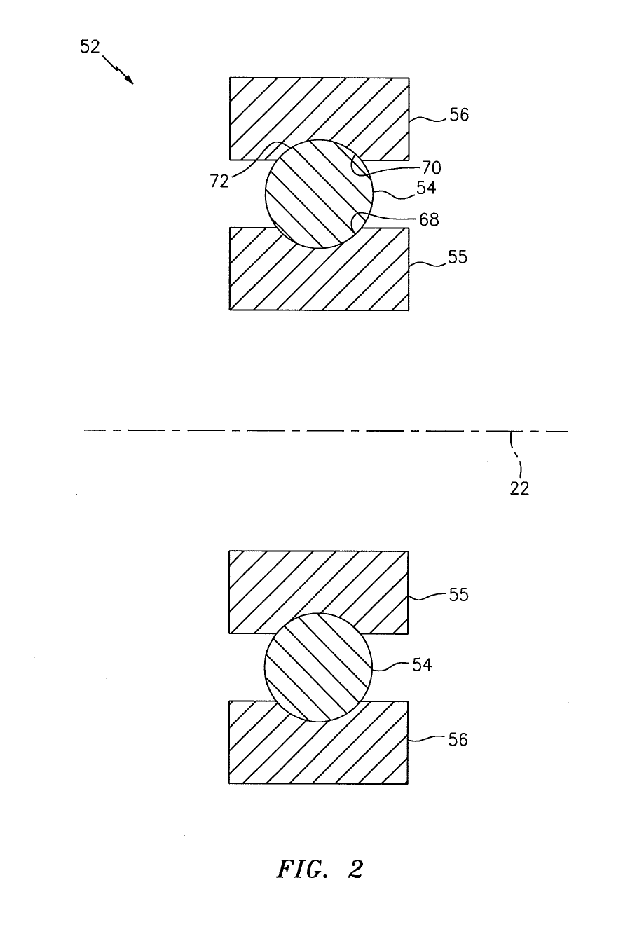

FIG. 2 is a side sectional illustration of one of the bearings 52 of FIG. 1. This bearing 52 is configured as a ball bearing. The bearing 52, however, may alternatively be configured as a cylindrical rolling bearing, a tapered rolling bearing, a spherical rolling bearing, a needle rolling bearing, or any other type of rolling element bearing. The bearing 52 includes one or more rolling elements 54, a bearing inner ring 55 and a bearing outer ring 56. The rolling elements 54 are arranged circumferentially around the axis 22, and radially between the inner ring 55 and the outer ring 56.

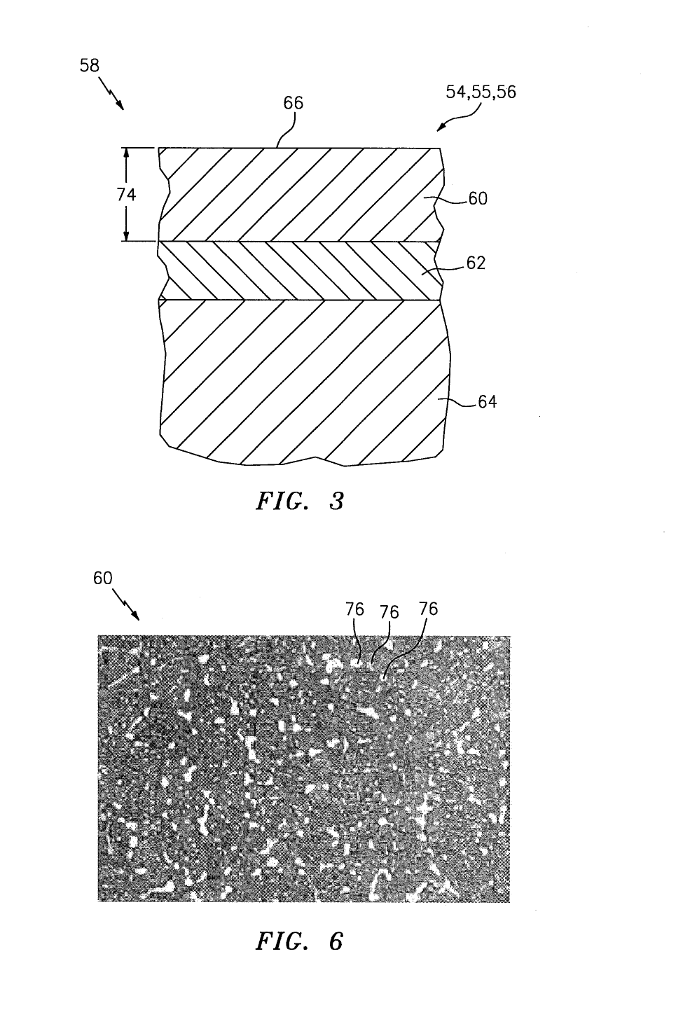

One or more of components 58 (see FIG. 3) of the bearing 52, such as one or more of the rolling elements 54, the inner ring 55 and the outer ring 56, are each formed from processed martensitic stainless steel. The processed martensitic stainless steel may be composed of iron (Fe), chromium (Cr), carbon (C) as well as one or more of the following: nitrogen (N), cobalt (Co), vanadium (V), molybdenum (Mo), nickel (Ni), manganese (Mn), silicon (Si), tungsten (W), titanium (Ti), and/or niobium (Nb). The present invention, however, is not limited to the foregoing material composition.

FIG. 3 illustrates an enlarged portion of one of the bearing components 58; e.g., one of the rolling elements 54, the inner ring 55 or the outer ring 56. The processed martensitic stainless steel of this component is configured with a hardened case 60, a transition region 62 and a core 64.

The hardened case 60 at least partially surrounds (e.g., covers or encapsulates) the transition region 62 and the core 64. The hardened case 60 defines an exterior surface 66 of the bearing component 58 such as, for example, a raceway surface 68, 70 of one of the rings 55, 56 or a contact surface 72 of one of the rolling elements 54 (see FIG. 2). The hardened case 60 extends from the exterior surface 66 towards the core 64 and to the transition region 62, thereby defining a hardened case depth 74. This depth 74 may be substantially equal to or greater than about two times (2×) a depth of a maximum von-Mises shear stress (σ). The depth 74, for example, may be substantially equal to or greater than about one one hundredths (0.01) of an inch (e.g., ˜0.0254 centimeters) for a relatively lightly loaded bearing; e.g., a bearing having a mean stress between about 100 ksi and about 150 ksi. In another example, the depth 74 may be substantially equal to or greater than about six one hundredths (0.06) of an inch (e.g., ˜0.1524 centimeters) for a relatively heavily loaded bearing; e.g., a bearing having a mean stress between about 200 ksi and about 300 ksi.

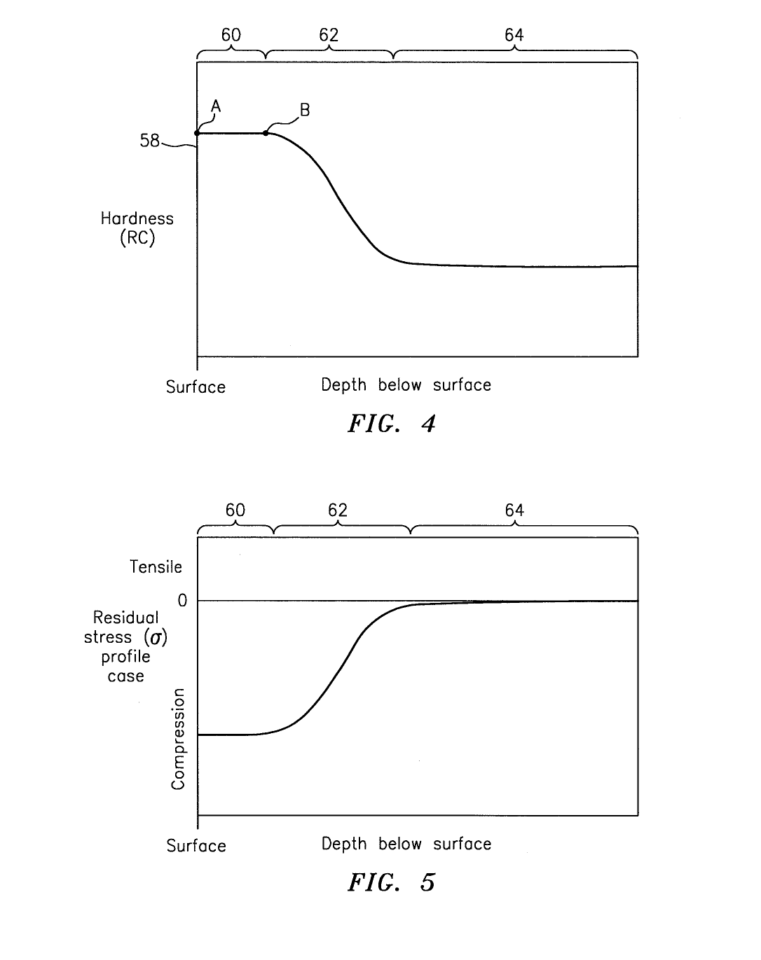

Referring to FIG. 4, the hardened case 60 has a hardness that is substantially equal to or greater than about fifty eight on the Rockwell scale (58 RC). Alternatively, the hardness may be substantially equal to or greater than about sixty four on the Rockwell scale (64 RC) to further increase the load bearing capability of the bearing component 58. The hardness of the hardened case 60 may be substantially uniform as the case 60 extends from the exterior surface 66 to the transition region 62. For example, the hardness of the hardened case 60 at (e.g., on, adjacent or proximate) the exterior surface 66 (point A) may be substantially equal to the hardness of the hardened case 60 at an intersection of the case 60 and the transition region 62 (point B).

Referring to FIG. 5, the hardened case 60 has a residual compressive stress that is substantially equal to or greater than about five thousand pounds per square inch (5 ksi). This may be enabled, for example, by a martensite start transformation temperature of the hardened case 60 being (e.g., at least ten degrees Fahrenheit—10° F.) lower than a martensite start transformation temperature of the unprocessed martensitic stainless steel.

The processed martensitic stainless steel of the hardened case 60 has a substantially uniform grain size that is substantially equal to or finer than ASTM (American Society for Testing and Materials) grain size #7. Alternatively, the grain size may be substantially equal to or finer than ASTM grain size #9; e.g., from about ASTM grain size #9 and to about ASTM grain size #12, or finer. The foregoing relatively fine grain sizes may strengthen the case 60, increase case 60 microstructural uniformity, and/or increase a rolling contact fatigue (RCF) resistance of the case 60. These characteristic(s) may in turn reduce a propensity for a crack to propagate through the case 60 and the bearing component 58. A grain size of ASTM grain size #9 or finer may also provide the case 60 with a relatively high compressive strength and/or a relatively high ductility.

The processed martensitic stainless steel of the hardened case 60 includes between about eight tenths of one percent (0.8%) and about four percent (4%) by weight of the carbon. A volume fraction of the carbon in the hardened case 60 may be substantially equal to or greater than about five percent (5%) by volume. Referring to FIG. 6, the carbon forms molecules 76 within the hardened case 60 such as, for example, carbides and/or carbo-nitrides with moderate, fine or ultra fine sizes; e.g., particle sizes between about 0.01 to about 100 microns. Examples of a carbide include, but are not limited to, M₆C, M₂C, M₂₃C₆ or a combination thereof “M” represents a metal such as, for example, chromium, molybdenum, nickel, cobalt, titanium or a combination thereof, and “C” represents carbon. The molecules 76 that include carbon are substantially uniformly dispersed within the processed martensitic stainless steel and the hardened case 60. Such a uniform dispersion may increases the strength and ductility of the processed martensitic stainless steel as compared to steel with carbides (e.g., MC, or M₇C₃) formed around its grain boundaries during carburization.

The processed martensitic stainless steel of the hardened case 60 includes approximately six percent (6%) by weight or more of the chromium. For example, the processed martensitic stainless steel of the hardened case 60 may include between about six percent (6%) and about eight percent (8%) by weight chromium to balance corrosion resistance with tribological performance. With such chromium content, the hardened case 60 may favorably react with an anti-wear oil additive (e.g., Tri-cresyl phosphate (TCP)) to form a high compressive stress, low shear stress tribological film. Such a tribological film may prevent metal-metal contact under boundary lubrication conditions and improve resistance to adhesive wear.

The processed martensitic stainless steel of the hardened case 60 may also include between about two percent (2%) and about twenty percent (20%) by volume retained austenite. The processed martensitic stainless steel of the hardened case 60 may also or alternatively include molybdenum, nitrogen and/or various other materials to increase environmental resistance of the case 60.

Referring to FIG. 3, the transition region 62 at least partially surrounds (e.g., covers or encapsulates) the core 64. The transition region 62 extends between the hardened case 60 and the core 64. Referring to FIG. 4, the transition region 62 has a hardness that gradually transitions down from the hardness of the hardened case 60 to that of the core 64. Referring to FIG. 5, the transition region 62 has a residual compressive stress that gradually transitions from the stress of the hardened case 60 down to that of the core 64.

Referring to FIG. 4, the core 64 has a substantially uniform hardness that is less than that of the hardened case 60. Referring to FIG. 5, the core 64 may have substantially little or zero residual compressive stress. The core 64 may have a fracture toughness that is substantially equal to or greater than approximately twenty five thousand pounds per square inch square root inch (25 ksi √in). The processed martensitic stainless steel of the core 64 includes approximately eight percent (8%) by weight or more of the chromium; e.g., between 12% and 18% by weight of the chromium.

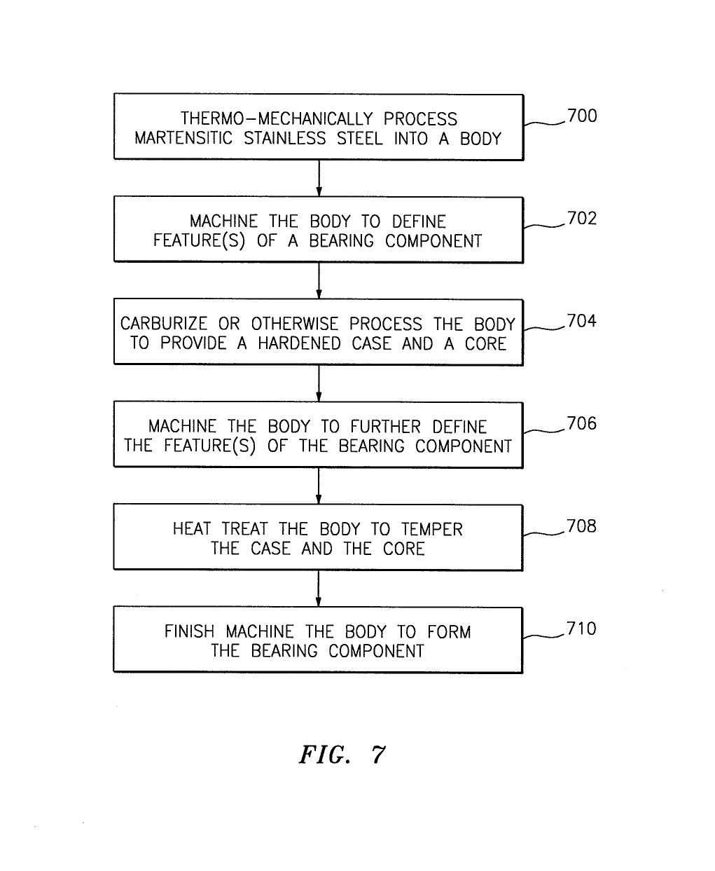

FIG. 7 is a flow diagram of a process for forming a component using unprocessed martensitic stainless steel. For ease of description, this process is described below for forming the bearing component 58 of FIG. 3. However, the present process may alternatively be performed to form various components of a turbine engine other than the bearing component 58 such as, for example, a gear, a shaft, a bearing support, a ball screw, etc. In addition, the present method may be performed to form components other than those included in a turbine engine.

The term “unprocessed” is used to indicate the martensitic stainless steel has not yet undergone the process of FIG. 7. However, the unprocessed martensitic stainless steel may or may not have been pre-processed with one or more other processes.

The unprocessed martensitic stainless steel may have a composition of:
between about eight percent (8%) and about eighteen percent (18%) by weight chromium;
up to about sixteen percent (16%) by weight cobalt;
up to about five percent (5%) by weight vanadium;
up to about eight percent (8%) by weight molybdenum;
up to about eight percent (8%) by weight nickel;
up to about four percent (4%) by weight manganese;
up to about two percent (2%) by weight silicon;
up to about six percent (6%) by weight tungsten;
up to about two percent (2%) by weight titanium;
up to about four percent (4%) by weight niobium; and
the balance iron.

An example of such an unprocessed martensitic stainless steel is PYROWEAR® 675 stainless steel (manufactured by Carpenter Technology Corp. of East Hartford, Conn., United States), which has a composition of: 13% wt Cr; 5.4% wt Co; 1.8% wt Mo; 2.6% wt Mn; 0.6% wt V; 0.4% wt Si; 0.07% wt C; and balance Fe. The present invention, however, is not limited to any particular unprocessed martensitic stainless steels.

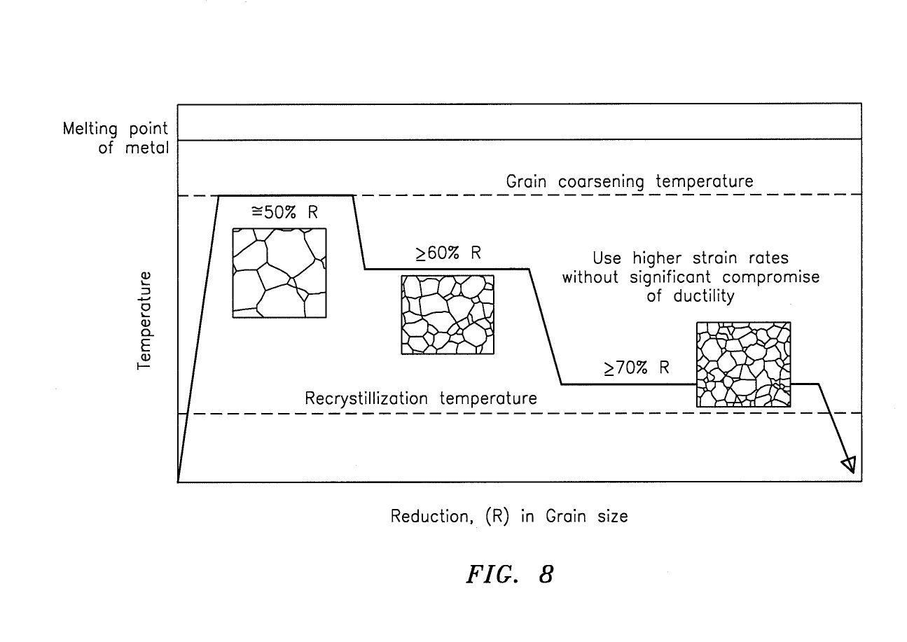

In step 700, the unprocessed martensitic stainless steel is thermo-mechanically processed into a body with a shape and size that generally corresponds to that of the bearing component 58. Bar stock of the unprocessed martensitic stainless steel, for example, may be forged and/or rolled at one or more elevated temperatures. During this forging, a grain size of the stainless steel may be reduced from a relatively coarse grain to a relatively fine grain of ASTM grain size #7 or finer by reducing temperature of the steel according to a stepped temperature schedule as illustrated in FIG. 8. This relatively fine grain size provides the stainless steel with a relatively high grain boundary area per unit volume.

In step 702, the body is rough machined to define one or more features (e.g., surfaces, holes, channels, etc.) of the bearing component 58 into the body.

In step 704, the body is carburized or alternatively nitrided or carbonitrided to provide a hardened case around a core. For example, a predetermined amount of carbon (e.g., between 0.8 and 4% wt) is diffused into the body using, for example, a vacuum carburization, plasma-assisted carburization or gas carburization. The carbon may rapidly diffuse into the stainless steel as a result of the relatively high grain boundary area per unit volume, which promotes substantially uniform diffusion of the carbon into the stainless steel. The diffused carbon may form carbide molecules (e.g., M₆C, M₂C, M₂₃C₆) with other materials within the stainless steel such as the chromium and/or molybdenum, thereby defining the case. These carbide molecules are substantially uniformly dispersed within the case as a result of the substantially uniform diffusion of the carbon into the stainless steel. Alternatively, the carbon may form carbo-nitrides where the body is carbo-nitrided.

In step 706, the body is machined to further define one or more features of the bearing component 58 into the body.

In step 708, the body is heat treated using an interrupted quenching and tempering process. For example, the body is quenched from an austenitizing temperature to a temperature between a martensite finish transformation (Mf) temperature of the core and a martensite start transformation (Ms) temperature of the case in order to transform the steel of the core into untempered martensite. The body may be reheated to an elevated temperature to provide the core with a predetermined hardness and fracture toughness; e.g., to temper the core. The body may be quenched to room temperature to transform the steel of the case into untempered martensite. The body is subsequently tempered in cryogenic cycles to provide the case with a predetermined hardness and to lower the retained austenite in the case. Notably, by interrupting the tempering prior to transforming the steel of the case into untempered martensite as described above, the core may be may be tempered to provide a relatively high fracture toughness without affecting the hardness of the case.

In some embodiments, the case may be high temperature tempered. The case, for example, may be tempered at a temperature between about eight hundred and fifty (850) and about eleven hundred (1100) degrees Fahrenheit (e.g., ˜482-593° C.). Such a high temperature temper may provide a relatively low volume fraction of retained austenite within the case; e.g., three (3) to fifteen (15) percent by volume. The high temperature temper may also precipitate M₂₃C₆ in the transformed martensite to a dispersion strengthened condition. The remaining retained austenite may maintain a relatively high strength and a relatively low toughness.

In other embodiments, the case may be low temperature tempered. The case, for example, may be tempered at a temperature between about four hundred (400) and about six hundred and fifty (650) degrees Fahrenheit (e.g., ˜204-343° C.). Such a low temperature temper may provide a relatively high volume fraction of retained austenite within the case; e.g., eight (8) to fifteen (15) by volume. The low temperature temper may be performed without carbide precipitation. The low temperature temper may provide a lower hardness than the high temperature temper, but may provide a high level of surface compressive residual stress and corrosion resistance.

In step 710, the body is finished machined to form the bearing component 58.

The bearing 25 and its components may have various configurations and may be formed from various materials other than those described above and illustrated in the drawings. One of the rings 55 and 56, for example, may be formed integral with another component such as, for example, a gear and/or a shaft. The bearing 25 may be configured as a hybrid bearing with case hardened stainless steel rings and ceramic rolling elements. For example, one or more of the rolling elements 54 may each be fowled from ceramic such as, for example, silicon nitride (Si₃N₄), or any other material. One or more of the rings 55 and 56 may each be formed from the processed martensitic stainless steel. Alternatively, one or more of the rings 55 and 56 may each be formed from a metal other than the processed martensitic stainless steel such as, for example, AMS 6490 or 6491 steel (e.g., M50 steel, which is available from Carpenter Technology Corp. of Pennsylvania, USA), AMS 6278 steel (e.g., M50NiL steel, which is available from Carpenter Technology Corp.), AMS 5898 steel (e.g., Cronidur® X30 steel, which is available from Energietechnik Essen GmbH of Essen, German), or other similar materials. The present invention therefore is not limited to any particular bearing or bearing component configurations or materials.

The bearing 25 may be included in various turbine engines other than the one described above as well as in other types of rotational equipment. The bearing, for example, may be included in a geared turbine engine where a gear train connects one or more shafts to one or more rotors in a fan section, a compressor section and/or any other engine section. Alternatively, the bearing may be included in a turbine engine configured without a gear train. The bearing may be included in a geared or non-geared turbine engine configured with a single spool, with two spools (e.g., see FIG. 1), or with more than two spools. The turbine engine may be configured as a turbofan engine, a turbojet engine, a propfan engine, or any other type of turbine engine. The present invention therefore is not limited to any particular types or configurations of turbine engines or rotational equipment.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined within any one of the aspects and remain within the scope of the invention. Accordingly, the present invention is not to be restricted except in light of the attached claims and their equivalents.

1. A rolling element bearing, comprising:
a plurality of bearing components including one or more rolling elements, an inner ring and an outer ring;
a first of the bearing components comprising martensitic stainless steel configured with a core and a hardened case the martensitic stainless steel of the core including approximately 8% by weight or more chromium; and
the martensitic stainless steel of the hardened case having a grain size that is substantially equal to or finer than ASTM grain size #7, and including approximately 6% by weight or more chromium, and carbon;
wherein molecules that include the carbon are substantially uniformly dispersed within the hardened case.

2. The hearing of claim 1, wherein the martensitic stainless steel further includes at least one of nitrogen, manganese, nickel, molybdenum, tungsten and silicon.

3. The bearing of claim 1, wherein the hardened case has a depth that extends from a surface of the first of the bearing components towards the core, and the depth is substantially equal to between approximately 0.01 and approximately 0.06 inches.

4. The bearing of claim 1, wherein the hardened case has a hardness that is substantially equal to or greater than about 58 RC.

5. The bearing of claim 1, wherein the hardened case has a substantially uniform hardness.

6. The bearing of claim 1, wherein the hardened case has a compressive stress that is substantially equal to or greater than approximately 5 ksi.

7. The bearing of claim 1, wherein the core has a fracture toughness that is substantially equal to or greater than approximately 25 ksi square root inch.

8. The bearing of claim 1, wherein the grain size is substantially equal to or finer than ASTM grain size #9.

9. The bearing of claim 1, wherein the martensitic stainless steel of the hardened case comprises between approximately 0.8 and approximately 4 percent by weight of the carbon.

10. The bearing of claim 1, wherein the molecules including the carbon comprise at least one of carbides and carbo-nitrides.

11. The bearing of claim 10, wherein a volume fraction of the at least one of carbides and carbo-nitrides within the hardened case is substantially equal to or greater than about 5 percent by volume.

12. The bearing of claim 10, wherein the at least one of carbides and carbo-nitrides have a particle size between approximately 0.01 microns and approximately 100 Microns.

13. The bearing of claim 1, wherein the martensitic stainless steel of the hardened case comprises between about 2 and about 20 percent retained austenite.

14. The bearing of claim 1, wherein the first of the bearing components comprises one of the rolling elements.

15. The bearing of claim 1, wherein the first of the bearing components comprises one of the inner ring and the outer ring.

16. The bearing of claim 15, wherein at least one of the rolling elements comprises ceramic.

17. A rolling element bearing, comprising:
plurality of bearing components including one or more rolling elements, an inner ring and an outer ring;
a first of the bearing components comprising martensitic stainless steel that includes iron, chromium, cobalt, vanadium, molybdenum, nickel, manganese, silicon and carbon;
a core of the martensitic stainless steel including approximately 8% by weight or more of the chromium; and
a case of the martensitic stainless steel having a grain size that is substantially equal to or finer than ASTM grain size #7, and including approximately 6% by weight or more of the chromium, and between approximately 0.8 and approximately 4 percent by weight of the carbon;
wherein molecules including the carbon are substantially uniformly dispersed within the case.

18. A martensitic stainless steel component, comprising:
a body comprising martensitic stainless steel;
a core of the martensitic stainless steel comprising about 8% by weight or more chromium; and
a hardened case of the martensitic stainless steel having a grain size that is substantially equal to or finer than ASTM grain size #7, and comprising about 6% by weight or more Chromium, and carbon;
wherein molecules including the carbon are substantially uniformly dispersed within the hardened case.

19. The component of claim 18, wherein the body forms a component of a rolling element bearing.

20. The component of claim 18, wherein the hardened case has a hardness that is substantially equal to or greater than about 58 RC.
